(19) United States
(12) Patent Application Publication
(10) Pub. No.: US 2022/0088929 A1
(43) Pub. Date: Mar. 24, 2022

(54) LIQUID DISCHARGE HEAD AND LIQUID DISCHARGE APPARATUS

(71) Applicant: TOSHIBA TEC KABUSHIKI KAISHA, Tokyo (JP)

(72) Inventor: Kazuhisa KIMURA, Hiratsuka Kanagawa (JP)

(21) Appl. No.: 17/355,945

(22) Filed: Jun. 23, 2021

(30) Foreign Application Priority Data
Sep. 23, 2020 (JP) 2020-158284

(51) Int. Cl. B41J 2/14; B41J 2/03; B41J 2/175

(52) U.S. Cl. CPC B41J 2/14314; B41J 2/175; B41J 2/03

(57) ABSTRACT

According to one embodiment, a liquid discharge head includes an actuator with a plurality of pressure chambers. A cover covers one side of the actuator and includes a common liquid chamber that connects to the plurality of pressure chambers and an air bubble venting flow path connected to the common liquid chamber. A nozzle plate is on a side of the actuator opposite the common liquid chamber and includes a plurality of first nozzles that faces the plurality of pressure chambers and a second nozzle that faces an outlet of the air bubble venting flow path. A mask plate covers the nozzle plate on a side opposite of the actuator and has a first window exposing the plurality of first nozzles and a second window exposing the second nozzle.

### CROSS-REFERENCE TO RELATED APPLICATION

This application is based upon and claims the benefit of priority from Japanese Patent Application No. 2020-158284, filed Sep. 23, 2020, the entire contents of which are incorporated herein by reference.

### FIELD

Embodiments described herein relate generally to a liquid discharge head and a liquid discharge apparatus.

### BACKGROUND

A liquid discharge head used in various liquid discharge apparatuses discharges liquid from a nozzle using an actuator in or adjacent to a liquid chamber. The actuator is then driven to discharge liquid from the liquid chamber. In such a liquid discharge head, air bubbles can be generated in a liquid chamber connected to multiple nozzles in common. If air bubbles are generated in the common liquid chamber, the discharge of the liquid may be adversely affected. Therefore, a liquid discharge head that suctions air bubbles from the liquid chamber using a suction nozzle is also known.

### BRIEF DESCRIPTION OF THE DRAWINGS

FIG. 1 depicts of a liquid discharge apparatus according to an embodiment.

FIG. 2 depicts a configuration of a liquid discharge apparatus.

FIG. 3 is a block diagram of a liquid discharge apparatus.

FIG. 4 is a perspective view of a liquid discharge head and a suction nozzle of a liquid discharge apparatus.

FIG. 5 is a perspective view of a liquid discharge head.

FIG. 6 is a perspective view of a liquid discharge head.

FIG. 7 is a perspective view of a suction nozzle.

FIG. 8 is a plan view of a liquid discharge head and a suction nozzle from a mask plate side in a partial cross section.

FIG. 9 is a cross-sectional view of a liquid discharge head and a suction nozzle.

FIG. 10 is another cross-sectional view of a liquid discharge head and a suction nozzle.

FIG. 11 is another cross-sectional view of a liquid discharge head and a suction nozzle.

FIG. 12 is a flowchart of aspects of a maintenance process of a liquid discharge apparatus.

FIG. 13 is a flowchart of additional aspects of a maintenance process of a liquid discharge apparatus.

FIG. 14 is a flowchart of additional aspects of a maintenance process of a liquid discharge apparatus.

FIG. 15 is a flowchart of another example of aspects of a maintenance process of a liquid discharge apparatus.

FIG. 16 is a perspective view illustrating a configuration of a conventional liquid discharge head.

FIG. 17 is an enlarged cross-sectional view illustrating a configuration of main parts of a conventional liquid discharge head.

FIG. 18 is a perspective view of a liquid discharge head according to another embodiment.

FIG. 19 is another perspective view of a liquid discharge head according to another embodiment.

FIG. 20 is a plan view of a liquid discharge head and a suction nozzle from a mask plate side in a partial cross-section.

### DETAILED DESCRIPTION

Embodiments provide a liquid discharge head and a liquid discharge apparatus capable of efficiently removing air bubbles.

In general, according to one embodiment, a liquid discharge head comprises an actuator with a plurality of pressure chambers and a cover covering one side of the actuator. The cover includes a common liquid chamber that connects to the plurality of pressure chambers and an air bubble venting flow path connected to the common liquid chamber. A nozzle plate of the liquid discharge head is on a side of the actuator opposite the common liquid chamber and includes a plurality of first nozzles that faces the plurality of pressure chambers and a second nozzle that faces an outlet of the air bubble venting flow path. A mask plate of the liquid discharge head covers the nozzle plate on a side opposite of the actuator and includes a first window exposing the plurality of first nozzles and a second window exposing the second nozzle.

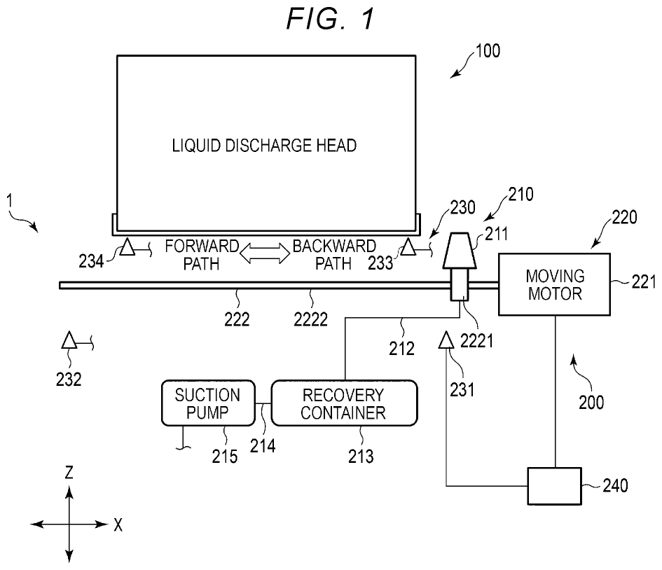

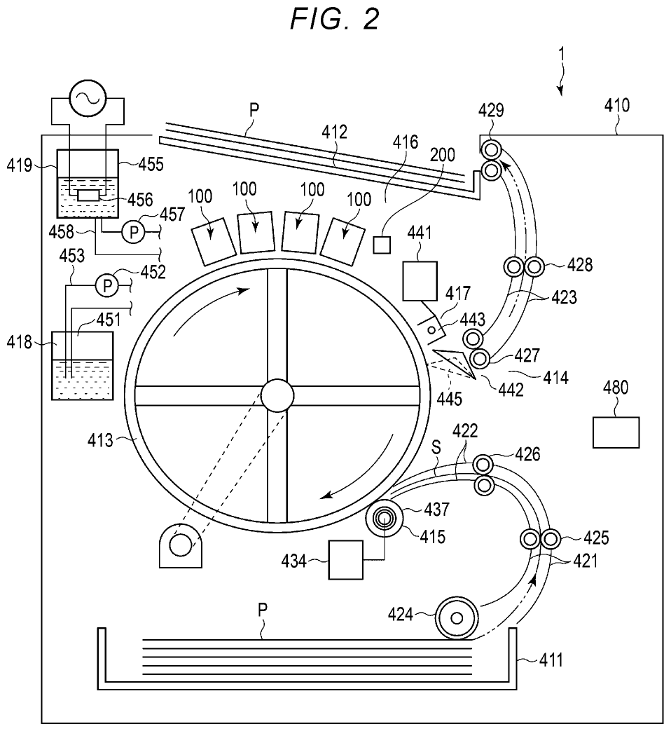

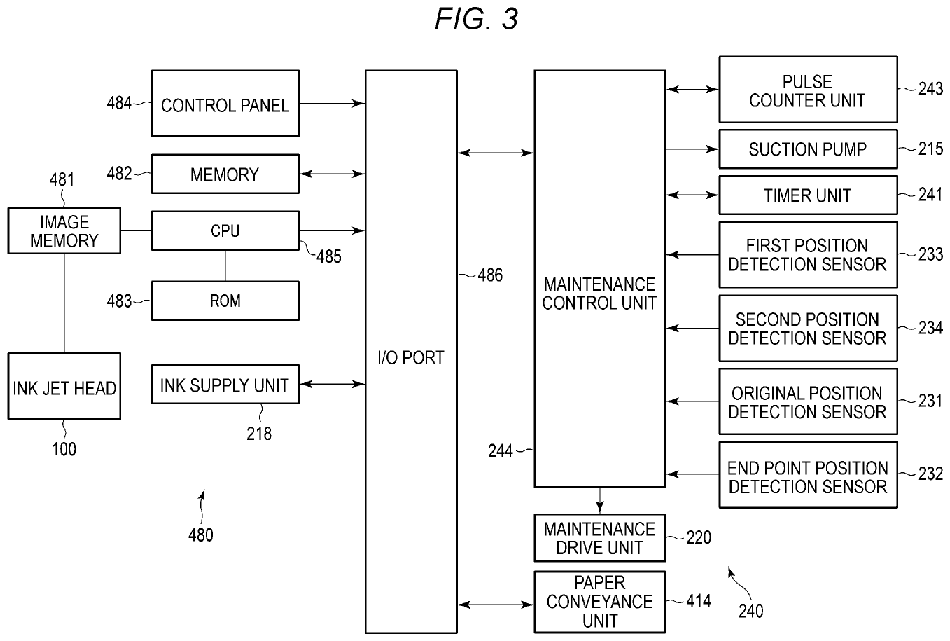

A liquid discharge head 100 and a liquid discharge apparatus 1 according to one embodiment will be described with reference to FIGS. 1 to 11. FIG. 1 is an explanatory diagram schematically illustrating the configuration of the liquid discharge apparatus 1. FIG. 2 is another explanatory diagram schematically illustrating the configuration of the liquid discharge apparatus 1. FIG. 3 is a block diagram schematically illustrating the configuration of the liquid discharge device 1.

In the following description, a Cartesian coordinate system of an X-axis, a Y-axis, and a Z-axis is used for purposes of description. The X-axis is along a first direction, which corresponds to an arrangement direction of nozzles. The Y-axis is along a second direction, which corresponds to an alignment direction of nozzle rows. The Z-axis is along a third direction, which corresponds to the direction in which droplets are discharged. For the sake of explanation in the various figures, aspects of the configuration can be illustrated as enlarged, reduced, or omitted from the illustration in whole or in part as appropriate.

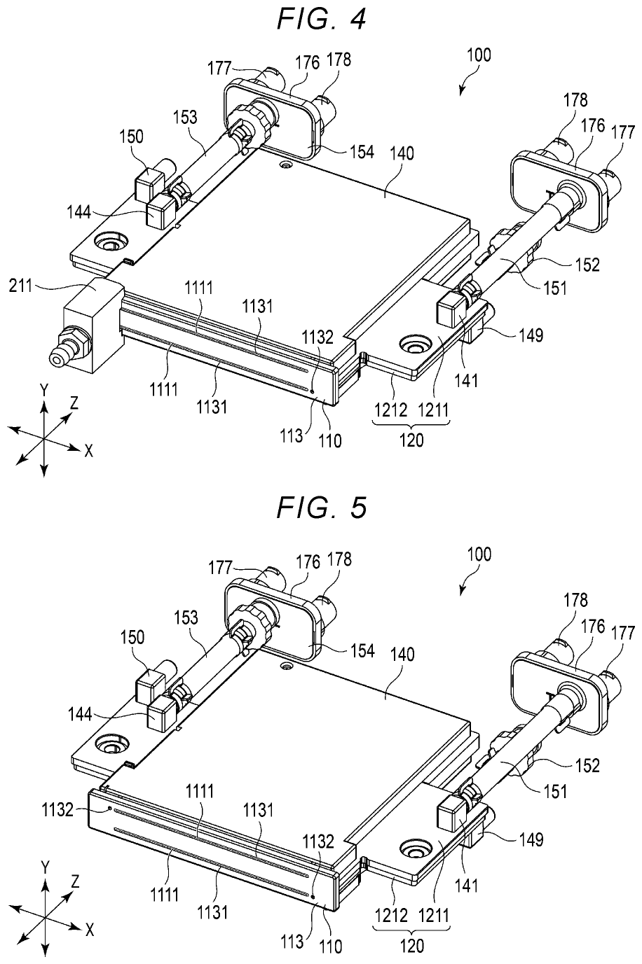

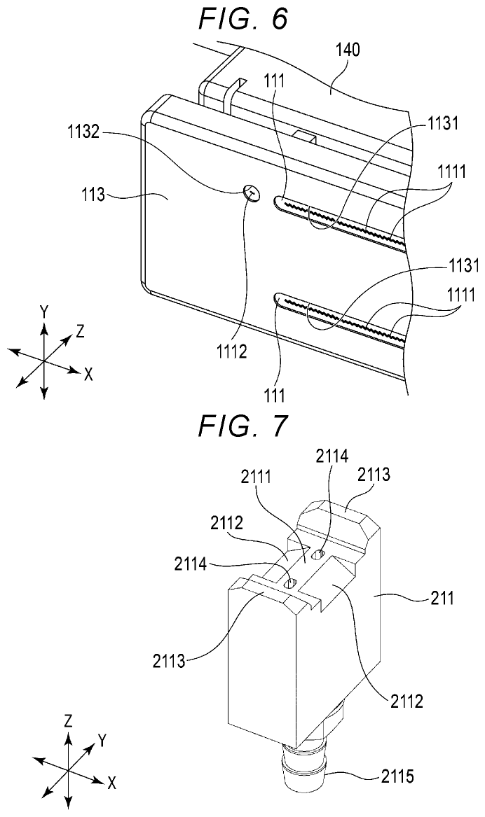

FIG. 4 is a perspective view illustrating the configuration of the liquid discharge head 100 and a suction nozzle 211 of the liquid discharge apparatus 1. FIG. 5 is a perspective view illustrating the configuration of the liquid discharge head 100. FIG. 6 is a perspective view illustrating the configuration of the liquid discharge head 100, in which the configuration of certain parts of a nozzle plate 111 and a mask plate 113 are illustrated in an enlarged manner. FIG. 7 is a perspective view illustrating the configuration of the suction nozzle 211.

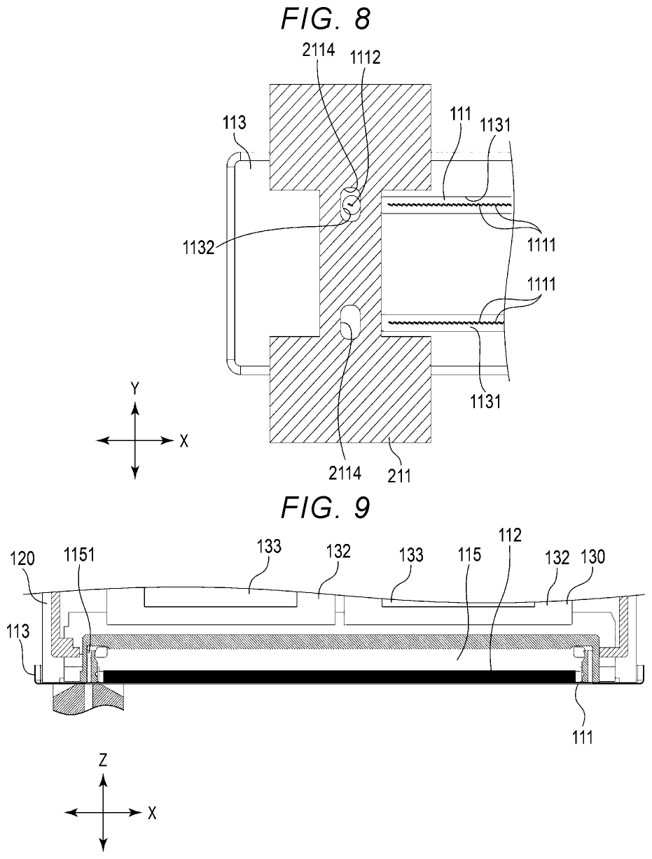

FIG. 8 is a plan view illustrating the configuration of the certain parts of the liquid discharge head 100 and the suction nozzle 211 from the mask plate 113 side in a partial cross section. FIG. 9 is a cross-sectional view illustrating the configuration of the certain parts of the liquid discharge head 100 and the suction nozzle 211.

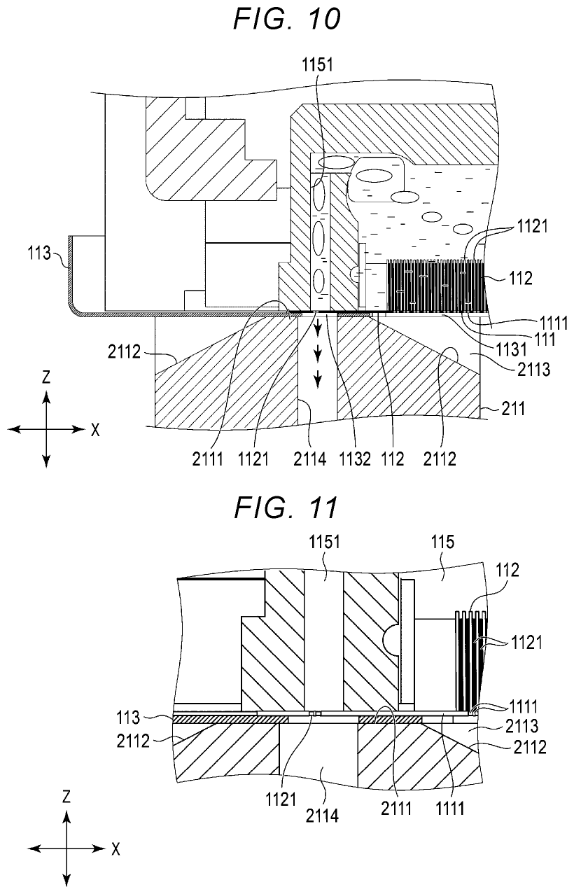

FIG. 10 is a cross-sectional view illustrating the configuration of certain parts of the liquid discharge head 100 and the suction nozzle 211. FIG. 11 is an enlarged cross-sectional view illustrating the configurations of a slit 1151 of a common liquid chamber 115, and a second nozzle group 1112 of the nozzle plate 111, and a nozzle hole 2114.

As illustrated in FIGS. 1 and 2, the liquid discharge apparatus 1 is an apparatus that performs various processes such as image formation while conveying, for example, paper P which is a recording medium.

As illustrated in FIG. 1, the liquid discharge apparatus 1 includes the liquid discharge head 100 and a maintenance device 200. As illustrated in FIG. 2, the liquid discharge apparatus 1 includes a casing 410 configuring an outer shell, a paper feed cassette 411 as a paper supply unit, a paper discharge tray 412 as a discharge unit, a holding roller 413 as a moving device that moves paper P relative to the liquid discharge head 100 by holding paper P on the outer surface thereof and rotating paper P, a conveyance device 414, a holding device 415, an image forming device 416, a destaticizing and peeling device 417 (referred to as peeling device 417 for simplicity), and a plurality of liquid supply devices 418. The liquid discharge apparatus 1 may include a plurality of temperature control devices 419.

The liquid discharge head 100 is, for example, a two-color head having two systems of ink flow paths and drive systems and discharging two different types of ink. When the same ink is used for the two systems, a monochromatic ink head having twice the resolution will be obtained. As illustrated in FIGS. 3 and 4, the liquid discharge head 100 includes a liquid discharge unit 110, a base unit 120, a plurality of circuit board units 130, a cover 140, a pair of ink supply pipes 151 and 154, and a pair of ink recovery pipes 153 and 152. The liquid discharge head 100 includes, for example, a supply pipe for temperature control and a recovery pipe for temperature control.

As illustrated in FIG. 2, a plurality of liquid discharge heads 100 are provided in, for example, the liquid discharge apparatus 1. In the present embodiment, the liquid discharge head 100 is a common liquid chamber circulation type head. In the liquid discharge head 100, for example, each ink flow path is connected to each of a pair of ink tanks 451 provided in the liquid discharge apparatus 1. The liquid discharge head 100 is provided in, for example, a circulation type ink circuit for circulating ink with the ink tank 451. The liquid discharge head 100 is disposed in the casing 410, for example, in a posture in which a nozzle group 1111 of the liquid discharge unit 110 faces downward and faces the holding roller 413.

As illustrated in FIGS. 6, 8 to 11, the liquid discharge unit 110 includes a nozzle plate 111, a pair of actuators 112, and a mask plate 113.

As illustrated in FIGS. 4 to 6 and 8, the nozzle plate 111 is a flat planar shape, and includes a plurality of first nozzles 1111 aligned along one direction and a second nozzle 1112 separated from the first nozzle 1111 positioned at least one end of the plurality of first nozzles 1111.

The nozzle plate 111 has a nozzle row formed by first nozzles 1111 arranged along the X-direction. The nozzle plate 111 can have one or more nozzle rows. In general, the number of nozzle rows will be the same the number of the actuators 112. In the present embodiment, two rows of nozzles 1111 are arranged, one row for each flow path.

Each first nozzle 1111 is a discharge nozzle (hole) for discharging a liquid. However, each first nozzle 1111 can be, for example, a group of closely spaced nozzles (holes). Therefore, each first nozzle 1111 will be described in the following as a first nozzle group 1111. A first nozzle group 1111 includes, for example, three nozzles. These three nozzles of the group are disposed side by side with each other in a direction intersecting the alignment direction (X-direction) of a nozzle row. In such a case, each first nozzle group 1111 includes three nozzles and several such first nozzle groups 1111 aligned in the X-direction as a nozzle row. Each nozzle is a through-hole that penetrates the nozzle plate 111. The axial direction of the nozzles of the first nozzle group 1111 is along the Z-direction.

As for the nozzle row(s), although an including a plurality of first nozzle groups 1111 is illustrated, the nozzle row may be a single first nozzle group 1111 in other examples.

The second nozzle 1112 is an air bubble venting nozzle (hole) for removing air bubbles from a common liquid chamber 115. The second nozzle 1112 can be, for example, a group of a plurality of closely spaced nozzles. Therefore, the second nozzle 1112 will be described in the following as a second nozzle group 1112. The second nozzle group 1112 has, for example, three nozzles. The three nozzles are disposed side by side along the X-direction. The second nozzle group 1112 is separated from the end of the first nozzle groups 1111 (end of a nozzle row) by a predetermined distance in the X-direction.

As a specific example, one second nozzle group 1112 is provided for each nozzle row. Therefore, since the nozzle plate 111 of the present embodiment includes two nozzle rows, two second nozzle groups 1112 are provided (though on opposite X-direction ends for the rows). For example, a second nozzle group 1112 is provided on an end portion side of a nozzle row corresponding to a secondary side of a common liquid chamber 115.

Although an example in which the air bubble venting nozzle for removing air bubbles in a common liquid chamber 115 includes the second nozzle group 1112 with three nozzles is described, in other examples the air bubble venting nozzle may include just a single nozzle.

Two actuators 112 are respectively provided on one side and the other side in the Y-direction along the thickness direction of the base unit 120, at the end portions of the base unit 120 on the nozzle plate 111 side. The two actuators 112 are disposed to face the nozzle plate 111.

As illustrated in FIGS. 10 and 11, the actuator 112 includes a plurality of pressure chambers 1121 spaced along the X-direction. Each actuator 112 has a common liquid chamber 115 communicating with the plurality of pressure chambers 1121. In each actuator 112, a plurality of drive element units for driving each pressure chamber 1121 are provided. In each actuator 112, the common liquid chamber 115 forms a path permitting ink flow from one end to the other end. In another actuator 112, a common liquid chamber 115 forms a path permitting ink flow to flow in the opposite end-to-end direction of the other actuator 112.

The pressure chambers 1121 respectively communicate with the first nozzle groups 1111 disposed to face the actuator 112. The pressure chambers 1121 are disposed side by side in one direction.

Electrodes are formed in each pressure chamber 1121. The electrodes are electrically connected to the circuit board unit 130.

As illustrated in FIGS. 9 to 11, the common liquid chamber 115 extends in X-direction, and forms a path permitting ink flow from one end to the other end of each actuator 112. The common liquid chamber 115 has an air bubble venting slit (air bubble venting flow path) 1151, which is a flow path provided for venting out air bubbles generated in the common liquid chamber 115, at the end portion in the X-direction.

As illustrated in FIGS. 9 and 10, the air bubble venting slit 1151 is a communication hole connecting from the inside of the common liquid chamber 115 to the nozzle plate 111. As illustrated in FIG. 10, the air bubble venting slit 1151 is formed in an L shape from an upper part of an end portion of the common liquid chamber 115 to the nozzle plate 111.

In the present embodiment, air bubble venting slits 1151 are provided on both end of the common liquid chamber 115 in the longitudinal direction (X-direction). One end of an air bubble venting slit 1151 communicates with the common liquid chamber 115, and the other end meets the nozzle plate 111. The end of one of the air bubble venting slit 1151 faces the second nozzle group 1112 provided on the nozzle plate 111. For example, as illustrated in FIG. 10, an inner surface of the common liquid chamber 115 around the air bubble venting slit 1151 is recessed more than other inner surfaces of the common liquid chamber 115.

The mask plate 113 covers at least an outer surface side of the nozzle plate 111. As a specific example, as illustrated in FIGS. 4 to 6 and 8 to 11, the mask plate 113 covers a main surface on the outer surface side of the nozzle plate 111, an outer peripheral side of the nozzle plate 111, and an outer peripheral side of the actuator 112.

As illustrated in FIGS. 4 to 6 and 8, the mask plate 113 includes a first window 1131 exposing a nozzle row composed of a plurality of first nozzle groups 1111 for discharging a liquid, and a second window 1132 exposing the second nozzle group 1112, which is an air bubble venting nozzle. In the present embodiment, since the nozzle plate 111 includes two nozzle rows, two first windows 1131 are provided on the mask plate 113. Since the nozzle plate 111 is provided with two second nozzle groups 1112, two second windows 1132 are also provided on the mask plate 113.

The first window 1131 is a hole formed in the mask plate 113. The first window 1131 is formed long in the X-direction along the aligning direction of the plurality of first nozzle groups 1111.

The second window 1132 is a hole formed in the mask plate 113. The second window 1132 is formed, for example, in a circular shape so that the second nozzle group 1112 can be disposed therein. The first window 1131 and the second window 1132 are separated from each other by a predetermined distance.

The base unit 120 is formed by being integrally assembled by laminating a pair of base plates 121 formed of a ceramic material in a plate shape. The base unit 120 is formed with a plurality of grooves in predetermined regions on the facing surfaces of the pair of base plates 121. These grooves form a first ink supply flow path, a first ink recovery flow path, a second ink supply flow path, a second ink recovery flow path, and a temperature control flow path between the pair of base plates 121.

The first ink supply flow path and the first ink recovery flow path communicate with the common liquid chamber 115 of an actuator 112. The first ink supply flow path communicates with one side of one common liquid chamber 115 in the longitudinal direction, and the first ink recovery flow path communicates with the other side of the common liquid chamber 115 in the longitudinal direction. The second ink supply flow path and the second ink recovery flow path communicate with another common liquid chamber 115 of the other actuator 112. The second ink supply flow path communicates with one side of the common liquid chamber 115 in the longitudinal direction, and the second ink recovery flow path communicates with the other side of the common liquid chamber 115 in the longitudinal direction. In this example, each actuator 112 has a separate common chamber 115.

The first ink supply flow path is connected to a first supply port 141 provided on one main surface side of the base unit 120, and the first ink recovery flow path is connected to a first recovery port 144 provided on one main surface side of the base unit 120.

The first supply port 141 is connected to an ink supply pipe 151, and the first recovery port 144 is connected to an ink recovery pipe 153. The first supply port 141 and the first recovery port 144 are connected to an ink tank 451 through a connection flow path 453 composed of a connection pipe such as a pipe-shaped member such as the ink supply pipe 151 and the ink recovery pipe 153.

The second ink supply flow path is connected to a second supply port provided on the other main surface side of the base unit 120, and the second ink recovery flow path is connected to a second recovery port provided on the other main surface side of the base unit 120.

The first supply port 141 is connected to the ink supply pipe 151, and the first recovery port 144 is connected to the ink recovery pipe 153. The first supply port 141 and the first recovery port 144 are connected to the ink tank 451 through the connection flow path 453 including a connection pipe such as a pipe-shaped member such as the ink supply pipe 151 and the ink recovery pipe 153.

The second supply port and the second recovery port are connected to the ink supply pipe 154 and the ink recovery pipe 152, and are connected to another ink tank 451 through the connection flow path 453 including a connection pipe such as a pipe-shaped member such as the ink supply pipe 154 and the ink recovery pipe 152.

An end portion on the primary side of the temperature control flow path is connected to a temperature control supply port 149 arranged on the other main surface side of the base unit 120, and an end portion on the secondary side of the temperature control flow path is connected to the temperature control recovery port 150 disposed on one main surface side of the base unit 120.

The temperature control supply port 149 and the temperature control recovery port 150 are connected to the supply pipe for temperature control and the recovery pipe for temperature control, respectively, and are connected to a hot water tank 455 through a connection flow path 458 composed of a connection pipe such as a pipe-shaped member such as the supply pipe for temperature control and the recovery pipe for temperature control.

The circuit board unit 130 includes a circuit board, a flexible wiring board 132, and a drive IC 133. Various electronic components and connectors are mounted on the circuit. For example, a plurality of flexible wiring boards 132 are disposed in parallel in the aligning direction of the pressure chambers 1121. The drive IC 133 is mounted on each of the plurality of flexible wiring boards 132. The flexible wiring board 132 is connected to the circuit board and the actuator 112.

The drive IC 133 is electrically connected to the electrodes formed in the pressure chamber 1121 through the flexible wiring board 132.

The liquid discharge head 100 applies a drive voltage to the electrodes of the actuator 112 by the drive IC to increase or decrease the volume of the pressure chamber 1121, thereby discharging droplets from the first nozzle group 1111 facing the pressure chamber 1121.

In the liquid discharge head 100, the ink as a liquid passes from each of the ink tanks through the first ink supply flow path, the second ink supply flow path of the supply pipes 151 and 154, and the base unit 120, respectively, and reaches the common liquid chambers 115 of the pair of actuators 112. The ink in the common liquid chamber 115 is discharged from the first nozzle group 1111 of the nozzle row disposed to face the pressure chamber 1121 by driving the pressure chamber 1121. The ink in the common liquid chamber 115 is recovered again in each ink tank 451 through the first ink recovery flow path, the second ink recovery flow path of the base unit 120, and the recovery pipes 153 and 152. The supply pipes 151 and 154 are provided with a filter 176. The filter 176 includes, for example, a supply port portion 177 and a venting outlet portion 178 for venting out air bubbles.

As illustrated in FIGS. 1 and 3, the maintenance device 200 includes a suction device 210, a maintenance drive unit 220, a position detection device 230, and a control device 240.

The suction device 210 includes a suction nozzle 211, a suction tube 212 connected to the suction nozzle 211, a recovery container 213 connected to the suction nozzle 211 through the suction tube 212, a coupling tube 214 connected to the recovery container 213, and a suction pump 215 connected to the recovery container 213 through the coupling tube 214.

The suction nozzle 211 includes a suction surface 2111, inclined surfaces 2112, wall portions 2113, nozzle holes 2114, and a pipe joint 2115.

The suction surface 2111 is provided at a portion of the suction nozzle 211 facing the nozzle plate 111 and the mask plate 113 of the liquid discharge head 100. The suction surface 2111 is a plane parallel to the outer surface of the nozzle plate 111 and the outer surface of the mask plate 113. The suction surface 2111 is set to have the same width as the width of the main surface of the mask plate 113 in the aligning direction of the pair of nozzle rows.

The inclined surfaces 2112 are provided on both sides of the suction surface 2111 of the suction nozzle 211 in the plane direction of the suction surface 2111 and in the direction (X-direction) orthogonal to the width direction (Y-direction) of the suction surface 2111. The inclined surfaces 2112 are inclined in the direction (Z-direction) of retracting from the liquid discharge head 100.

The wall portions 2113 are respectively formed at both end portions of the suction nozzle 211 in the width direction of the suction surface 2111. The wall portions 2113 engage with the edge of the mask plate 113 to guide or regulate positions of the liquid discharge head 100 and the suction nozzle 211.

The same number of nozzle holes 2114 as the number of nozzle rows are provided. In the present embodiment, since there are two nozzle rows, two nozzle holes 2114 are provided in the mask plate 113. The nozzle holes 2114 are flow paths provided in the suction nozzle 211. One end of the nozzle hole 2114 opens to the suction surface. The two nozzle holes 2114 face each of the two nozzle rows. The two nozzle holes 2114 join, for example, in the suction nozzle 211 and are connected to the pipe joint 2115. The pipe joint 2115 is formed in a tubular shape. The pipe joint 2115 is connected to the suction tube 21. Each nozzle hole 2114 is set to a size that allows the second nozzle group 1112 to be disposed. The distance between the first window 1131 and the second window 1132 of the mask plate 113 is set to a distance where the nozzle hole 2114 is not positioned in the first window 1131 when the nozzle hole 2114 faces the second window 1132.

In such a suction nozzle 211, at least in the maintenance process for performing suction, the suction surface 2111 is disposed through a predetermined gap with the outer surface of the nozzle plate 111 and the outer surface of the mask plate 113.

The recovery container 213 is a container for recovering the suctioned liquid. For example, the recovery container 213 is a bottle or a jar. The suction pump 215 is a pump for making the inside of the recovery container 213 negative pressure, for example, a diaphragm type pump.

The maintenance drive unit 220 relatively moves the liquid discharge head 100 and the suction nozzle 211. For example, the maintenance drive unit 220 is a conveyance device that moves the suction nozzle 211 with respect to the liquid discharge head 100 that performs the maintenance process. The maintenance drive unit 220 includes, for example, a moving motor 221 and a moving mechanism 222.

The moving motor 221 moves the suction nozzle 211 by driving the moving mechanism 222. The moving mechanism 222 is driven by the moving motor 221 to reciprocate the suction nozzle 211 in one direction (X-direction). For example, the moving motor 221 is a stepping motor that operates at a fixed angle each time a pulse signal is input.

For example, the moving mechanism 222 includes a moving body 2221 that supports the suction nozzle 211, and a driving body 2222 that is connected to a rotation shaft of the moving motor 221 and moves the moving body 2221 by the rotation of the moving motor 221. The moving body 2221 and the driving body 2222 convert the rotation into a linear movement. Such a moving mechanism 222 can be set in various ways. For example, the moving mechanism 222 can use a rotary liner, a linear actuator, a rack and pinion gear system, or the like. The moving mechanism 222 may be another directional conversion mechanism such as a belt conveyor. The moving mechanism 222 moves the suction nozzle 211 at least from a position facing the liquid discharge head 100 along the aligning direction of the plurality of first nozzle groups 1111 of the liquid discharge head 100.

In the present embodiment, the moving mechanism 222 reciprocates the suction nozzle 211 in one direction between the original position separated from the liquid discharge head 100 positioned at the position where a maintenance process is performed and the end point position where the suction nozzle 211 passes through the liquid discharge head 100 and then the maintenance process ends.

The position detection device 230 detects the position of the suction nozzle 211 and transmits the detected signal to the control device 240. The position detection device 230 detects the position of the suction nozzle 211 with respect to the liquid discharge head 100 in the maintenance process. For example, the position detection device 230 includes an original position detection sensor 231, an endpoint position detection sensor 232, a first position detection sensor 233, and a second position detection sensor 234.

The original position detection sensor 231 is a sensor that detects the suction nozzle 211 positioned at the original position. The original position detection sensor 231 detects the suction nozzle 211 positioned at the original position and outputs the signal to the control device 240. The endpoint position detection sensor 232 is a sensor that detects the suction nozzle 211 positioned at the end point position. The end point position detection sensor 232 detects the suction nozzle 211 positioned at the end point position and outputs the signal to the control device 240.

The first position detection sensor 233 is a sensor that detects the suction nozzle 211 positioned at a first position where the nozzle hole 2114 of the suction nozzle 211 faces one of the second nozzle groups 1112 existing on the original position side in the aligning direction (extending direction of nozzle row) of the plurality of first nozzle groups 1111. The first position detection sensor 233 detects the suction nozzle 211 at the first position and outputs the signal to the control device 240.

The second position detection sensor 234 is a sensor that detects the suction nozzle 211 positioned at a second position where the nozzle hole 2114 of the suction nozzle 211 faces the other of the second nozzle groups 1112 existing on the end point position side in the aligning direction of the plurality of first nozzle groups 1111. The second position detection sensor 234 detects the suction nozzle 211 at the second position and outputs the signal to the control device 240.

The control device 240 includes a timer unit 241, a pulse counter unit 243, and a maintenance control unit 244.

The timer unit 241 tracks the time. The timer unit 241 is, for example, a process circuit that generates time information.

The pulse counter unit 243 counts, for example, the pulse number and the pulse frequency of the pulse signal for controlling the moving motor 221 of the maintenance drive unit 220. The pulse counter unit 243 generates information required for movement control, such as speed and position of the suction nozzle 211, from the pulse number and the pulse frequency, and outputs the information to the maintenance control unit 244. The pulse counter unit 243 is a process circuit.

The maintenance control unit 244 is connected to the suction pump 215, the moving motor 221, the original position detection sensor 231, the endpoint position detection sensor 232, the first position detection sensor 233, the second position detection sensor 234, the timer unit 241, and the pulse counter unit 243. The maintenance control unit 244 is a control circuit for performing maintenance control. The maintenance control unit 244 includes a processor and a memory. The maintenance control unit 244 controls the suction pump 215 and the moving motor 221 based on information detected by the original position detection sensor 231, the end point position detection sensor 232, the first position detection sensor 233, the second position detection sensor 234, the timer unit 241, and the pulse counter unit 243, and executes the maintenance process of the liquid discharge head 100. The maintenance control unit 244 is connected to an I/O port 486 of a control unit 480.

As illustrated in FIG. 2, the paper feed cassette 411 is provided inside the casing 410 and holds paper P as a recording medium.

As illustrated in FIG. 2, the paper discharge tray 412 is provided on the upper part of the casing 410. The paper discharge tray 412 supports paper P discharged to the outside of the casing 410 by the conveyance device 414.

The holding roller 413 is formed in a cylindrical shape having a fixed length in the axial direction. The holding roller 413 conveys paper P by rotating while holding paper P on the surface thereof. Here, as the holding roller 413 rotates clockwise in FIG. 2, the holding roller 413 conveys paper P clockwise along the outer periphery thereof.

The holding device 415, the image forming device 416, and the peeling device 417 are provided in order from the upstream side to the downstream side in the outer peripheral portion of the holding roller 413.

The conveyance device 414 is a paper conveyance unit that conveys paper sheets or the like. The conveyance device 414 includes a plurality of guide members 421 to 423 and a plurality of conveyance rollers 424 to 429 provided along a conveyance path. The conveyance rollers 424 to 429 are driven by a conveyance motor and rotated to feed paper P towards the downstream side along the conveyance path 401. The conveyance device conveys paper P along a prescribed conveyance path from the paper feed cassette 411 through the outer periphery of the holding roller 413 to the paper discharge tray 412.

The holding device 415 includes a charging roller 437 disposed to face the surface of the holding roller 413. The charging roller 437 is formed in a columnar shape including a metal rotating shaft and a conductive rubber layer arranged around the rotating shaft. The charging roller 437 is configured to be able to switch a charge supply state and to move in a direction of coming into contact with or separating from the surface of the holding roller 413. The charging roller 437 is connected to a high voltage generating circuit. The holding device 415 presses paper P against the outer surface of the holding roller 413 to attract and hold paper P on the surface (outer peripheral surface) of the holding roller 413 and supplies power to the charging roller 437 in a state where the charging roller 437 is in close to the holding roller 413, thereby generating (charging) an electrostatic force in the direction of attracting paper P to the holding roller 413. Paper P is attracted to the surface of the holding roller 413 by such electrostatic force.

The image forming device 416 includes a plurality of liquid discharge heads 100 which are downstream of the charging roller 437 and are disposed to face a portion above the surface of the holding roller 413. The plurality of liquid discharge heads 100 are ink jet heads that discharge ink onto paper P from nozzles provided at a predetermined pitch to form an image.

The peeling device 417 destaticizes (discharges and/or removes electrostatic charge) paper P and peels off paper P from the holding roller 413. The peeling device 417 includes a destaticizing device 441 for destaticizing paper P and a peeling device 442 for peeling off paper P from the surface of the holding roller 413 after the destaticization.

The destaticizing device 441 includes a destaticizing roller 443 which is provided on the downstream side of the image forming device 416 in the direction, in which paper P is conveyed, and is chargeable. The destaticizing device 441 releases the attraction force by supplying electric charge to destaticize paper P and makes paper P easy to be peeled off from the holding roller 413.

The peeling device 442 includes a separation blade 445 provided on the downstream side of the destaticizing device 441 and capable of rotating (moving). The separation blade 445 can rotate between a peeling position where the separation blade 445 is inserted between paper P and the holding roller 413 and a retracting position where the separation blade 445 is retracted from the holding roller 413, and peels off paper P from the surface of the holding roller 413 in a state of being disposed at the peeling position.

The liquid supply device 418 is provided for each actuator 112 of each liquid discharge head 100. The liquid supply device 418 includes an ink tank 451 connected to the liquid discharge head 100, an ink pump 452 as a supply mechanism, and a pressure adjusting mechanism. The plurality of liquid supply devices 418 circulate the ink in the ink tank 451 with the liquid discharge head 100.

Each temperature control device 419 is provided for each liquid discharge head 100. The temperature control device 419 includes the hot water tank 455, a heater 456, and a hot water pump 457 as a supply mechanism. The hot water tank 455 is connected to the temperature control flow path of the liquid discharge head 100 through the hot water connection flow path 458 for hot water. The heater 456 heats the inside of the hot water tank 455 and adjusts the temperature of the water in the hot water tank 455 to a desired temperature by the control of the control unit. The temperature control device 419 sends the ink in the hot water tank 455 to the liquid discharge head 100 by a pump driven by the control of the control unit, and circulates water or hot water in the hot water tank 455 with the temperature control flow path of the liquid discharge head 100.

As illustrated in FIG. 3, the control unit 480 includes, for example, an image memory 481 and a memory 482 that temporarily store various variable data, image data, and the like, a read only memory (ROM) 483 that stores various programs and the like, a control panel 484 to make various settings, a central process unit (CPU) 485 as an example of a processor, and the I/O port 486 as an interface for receiving data from the outside and outputting data to the outside.

The image memory 481 stores image data and the like related to liquid discharge by the liquid discharge head 100.

The memory 482 stores various data, settings, and the like required for various processes such as a maintenance process. For example, the memory 482 stores the start position of the maintenance process defined for each liquid discharge head 100 and the order of the liquid discharge head 100 for performing the maintenance process. The memory 482 stores settings of the suction time and settings of the suction pressure for suction by the suction nozzle 211 in the maintenance process.

The control panel 484 notifies the user of information and receives a command from the user, for example, under the control of the CPU 485.

The CPU 485 implements various processes as the liquid discharge apparatus 1 based on the control program stored in the ROM 83. The CPU 485 is an example as a processor, and may be another process circuit.

In the liquid discharge head 100 and the liquid discharge apparatus 1, while driving to discharge the liquid from the nozzle group 1111, the CPU 485 of the control unit 480 controls the drive IC 133 based on data stored in the image memory 481 and applies a drive voltage to the actuator 112 to change the pressure in the pressure chambers and discharge ink droplets from the nozzle group 1111 disposed to face each pressure chamber.

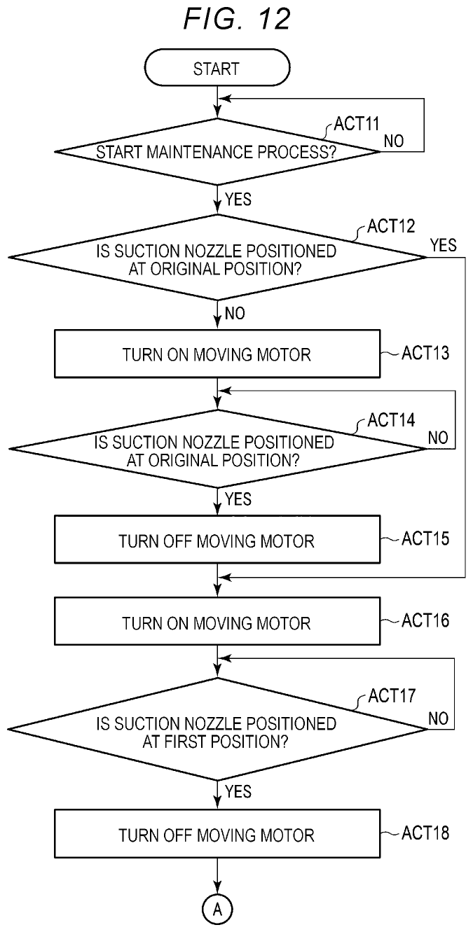

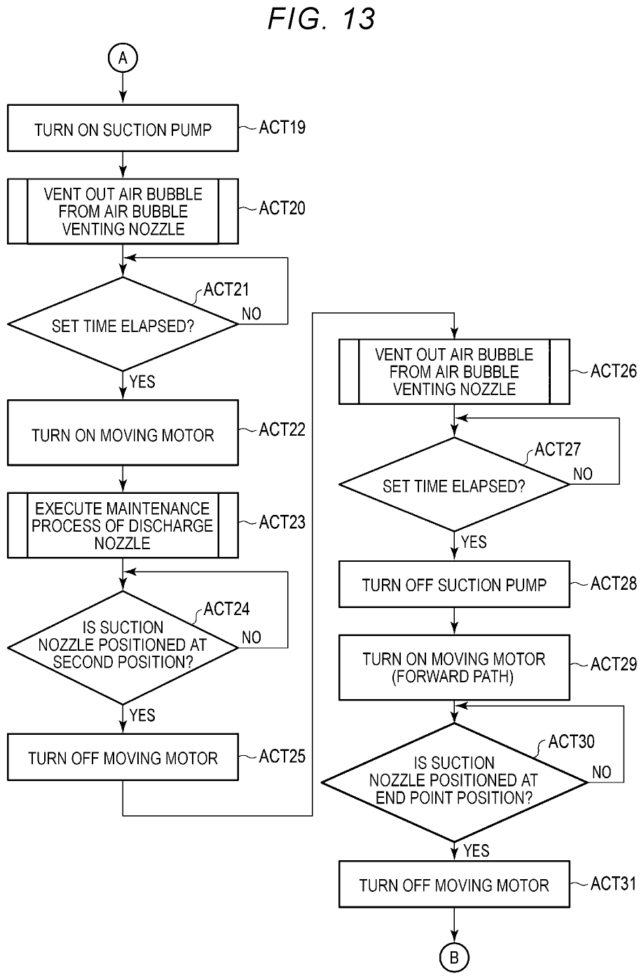

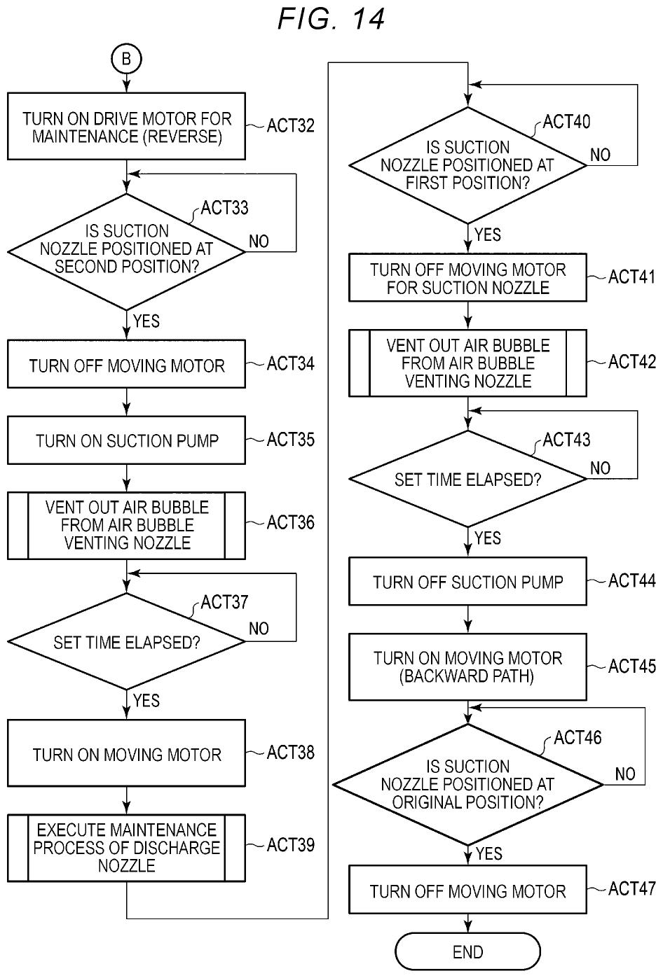

Next, an example of the maintenance process executed by the maintenance control unit 244 will be described with reference to the flowcharts of FIGS. 12 to 15.

First, as illustrated in FIG. 12, the maintenance control unit 244 determines whether to start the maintenance process (ACT 11). Here, the determination of the start of the maintenance process is performed based on, for example, the elapsed time or an instruction from the outside. The elapsed time is tracked by, for example, a time-tracking function of the timer unit 241 or a time-tracking function of the CPU 485 in conjunction with ROM 483. The elapsed time can be stored in the memory 482 or a memory of the maintenance control unit 244 as needed. In this context, an instruction from the outside is, for example, the result of an input operation on the control panel 484 or an instruction given by a user input from an external terminal connected to the I/O port 486 or the like.

For example, when the cumulative time for discharging the liquid from the liquid discharge head 100 has reached a predetermined time, the maintenance control unit 244 determines it is time to start the maintenance process. For example, the predetermined time here is stored as a threshold value in the memory 482 or the memory of the maintenance control unit 244 in advance. For example, when the cumulative time for which the liquid discharge head 100 is stopped has reached a predetermined time stored in various memories or the like, the maintenance control unit 244 determines it is time to start the maintenance process. For example, when a maintenance process instruction is input from the user, the maintenance control unit 244 determines it is time to start the maintenance process.

When it is not time to start the maintenance process (NO in ACT 11), the maintenance control unit 244 waits until a start condition of the maintenance process is satisfied. When it is time to start the maintenance process (YES in ACT 11), the maintenance control unit 244 next determines whether the suction nozzle 211 is positioned at the original position based on the signal from the original position detection sensor 231 (ACT 12). When it is determined that the suction nozzle 211 is positioned at the original position (YES in ACT 12), the maintenance control unit 244 drives the moving motor 221 (ACT 16) for the start of the maintenance process, and starts moving the suction nozzle 211 on the forward path.

When it is determined that the suction nozzle 211 is not positioned at the original position (NO in ACT 12), the maintenance control unit 244 drives the moving motor 221 (ACT 13) to move the suction nozzle 211.

Here, the maintenance control unit 244 detects the position of the suction nozzle 211 based on the information from, for example, the original position detection sensor 231, the end point position detection sensor 232, the first position detection sensor 233, the second position detection sensor 234, and the pulse counter unit 243, controls the moving motor 221, and moves the suction nozzle 211.

When the suction nozzle 211 is not located at the original position (NO in ACT 14), the maintenance control unit 244 continues the drive control of the moving motor 221. Once the suction nozzle 211 is moved to the original position (YES in ACT 14), the maintenance control unit 244 stops driving the moving motor 221 (ACT 15). Then, as the start of the maintenance process, the maintenance control unit 244 drives the moving motor 221 (ACT 16) and starts moving the suction nozzle 211 on the forward path.

When the movement of the suction nozzle 211 on the forward path is started, the maintenance control unit 244 monitors whether the suction nozzle 211 is positioned at the first position (ACT 17). When it is monitored that the suction nozzle 211 moved from the original position does not reach the first position (NO in ACT 17), the maintenance control unit 244 continues to monitor the position of the suction nozzle 211. When it is monitored that the suction nozzle 211 is positioned at the first position (YES in ACT 17), the maintenance control unit 244 stops the moving motor 221 (ACT 18). Then, the maintenance control unit 244 drives the suction pump 215 (ACT 19), and suctions air bubbles from the first nozzle group 1111 via the suction nozzle 211 (ACT 20). With such configuration, air bubbles in the common liquid chamber 115 are removed (together with some of the liquid) from the air bubble venting slit 1151, and the air bubble venting process in the common liquid chamber 115 is performed. The maintenance control unit 244 controls the timer unit 241 to track the elapsed time since the start of the air bubble venting process.

Next, the maintenance control unit 244 determines whether the elapsed time from the start of the air bubble venting process has reached an air bubble venting process time (set time) that has been set and stored in the memory 482, the memory of maintenance control unit 244, and the like in advance (ACT 21). When it is determined that the elapsed time from the start of the air bubble venting process has not reached the air bubble venting process time (NO in ACT 21), the maintenance control unit 244 continues the air bubble venting process. When it is determined that the elapsed time from the start of the air bubble venting process has reached the set time (YES in ACT 21), the maintenance control unit 244 drives the moving motor 221 (ACT 22) and causes the suction nozzle 211 to move on the forward path. The maintenance control unit 244 continues to drive the suction pump 215 while causing the suction nozzle 211 to move on the forward path. With such configuration, as the suction nozzle 211 passes through the nozzle row while suctioning, the maintenance control unit 244 executes the maintenance process of the first nozzle group 1111 (a nozzle row) (ACT 23). Here, the maintenance process of the first nozzle group 1111 is a cleaning process of removing remaining deposits such as liquid and paper dust adhering to the first nozzle group 1111 and the surroundings thereof by the suction nozzle 211.

The maintenance control unit 244 monitors whether the suction nozzle 211 is positioned at the second position (ACT 24). When it is monitored that the suction nozzle 211 that moves while performing the maintenance process does not reach the second position (NO in ACT 24), the maintenance control unit 244 continues the maintenance process of the suction nozzle 211. When it is monitored that the suction nozzle 211 is positioned at the second position (YES in ACT 24), the maintenance control unit 244 stops the moving motor 221 (ACT 25). Then, the maintenance control unit 244 continues to drive the suction pump 215, and removes air bubbles from the second nozzle group 1112 via the suction nozzle 211 (ACT 26). With such configuration, air bubbles in the common liquid chamber 115 are removed together with liquid via the air bubble venting slit 1151 in the common liquid chamber 115, and the air bubble venting process in the common liquid chamber 115 is performed. The maintenance control unit 244 controls the timer unit 241 to track the elapsed time since the start of the air bubble venting process.

Next, the maintenance control unit 244 determines whether the elapsed time since the start of the air bubble venting process has reached the air bubble venting process time (set time) that has been set and stored in the memory 482, the memory of maintenance control unit 244, and the like in advance (ACT 27). When it is determined that the elapsed time has not reached the air bubble venting process time (NO in ACT 27), the maintenance control unit 244 continues the air bubble venting process. When it is determined that the elapsed set time has been reached (YES in ACT 27), the maintenance control unit 244 stops the suction pump 215 (ACT 28), drives the moving motor 221 (ACT 29), and causes the suction nozzle 211 to move on the forward path.

When the maintenance control unit 244 starts moving the suction nozzle 211 on the forward path, the maintenance control unit 244 monitors whether the suction nozzle 211 is positioned at the endpoint position (ACT 30). When it is monitored that the suction nozzle 211 moved from the second position does not reach the end point position (NO in ACT 30), the maintenance control unit 244 continues to monitor the position of the suction nozzle 211. When it is monitored that the suction nozzle 211 is positioned at the end point position (YES in ACT 30), the maintenance control unit 244 stops the moving motor 221 (ACT 31). With such configuration, the air bubble venting process and the cleaning process as the maintenance process on the forward path are ended.

Next, the maintenance control unit 244 reverses the rotation direction of the moving motor 221 from the forward path, drives the moving motor 221 (ACT 32), and starts moving the suction nozzle 211 on the backward path.

When the maintenance control unit 244 starts moving the suction nozzle 211 on the backward path, the maintenance control unit 244 monitors whether the suction nozzle 211 is positioned at the second position (ACT 33). When it is monitored that the suction nozzle 211 moved from the end point position does not reach the second position (NO in ACT 33), the maintenance control unit 244 continues to monitor the position of the suction nozzle 211. When it is monitored that the suction nozzle 211 is positioned at the second position (YES in ACT 33), the maintenance control unit 244 stops the moving motor 221 (ACT 18). Then, the maintenance control unit 244 drives the suction pump 215 (ACT 35), and removes air bubbles from the second nozzle group 1112 by the suction nozzle 211 (ACT 36). With such configuration, the air bubbles in the common liquid chamber 115 are suctioned together with the liquid via the air bubble venting slit 1151 in the common liquid chamber 115, and the air bubble venting process in the common liquid chamber 115 is performed. The maintenance control unit 244 controls the timer unit 241 to track the elapsed time since the start of the air bubble venting process.

Next, the maintenance control unit 244 determines whether the elapsed time from the start of the air bubble venting process has reached the air bubble venting process time (set time) that has bene set and stored in the memory 482, the memory of maintenance control unit 244, and the like in advance (ACT 37). When it is determined that the elapsed time since the start of the air bubble venting process has not reached the set air bubble venting process time (NO in ACT 37), the maintenance control unit 244 continues the air bubble venting process. When it is determined that the elapsed time since the start of the air bubble venting process has reached the set time (YES in ACT 37), the maintenance control unit 244 drives the moving motor 221 (ACT 38) and causes the suction nozzle 211 to move on the backward path. The maintenance control unit 244 continues to drive the suction pump 215 while causing the suction nozzle 211 to move on the backward path. With this configuration, as the suction nozzle 211 passes through the nozzle row while suctioning, the maintenance control unit 244 executes the cleaning process of the first nozzle group 1111 (a nozzle row) (ACT 39).

The maintenance control unit 244 monitors whether the suction nozzle 211 is positioned at the first position (ACT 40). When it is monitored that the suction nozzle 211 that moves while performing the maintenance process does not reach the first position (NO in ACT 40), the maintenance control unit 244 continues the maintenance process of the suction nozzle 211. When it is monitored that the suction nozzle 211 is positioned at the second position (YES in ACT 24), the maintenance control unit 244 stops the moving motor 221 (ACT 41). Then, the maintenance control unit 244 continues to drive the suction pump 215, and removes air bubbles from the first nozzle group 1111 by the suction nozzle 211 (ACT 42). With this configuration, the air bubbles in the common liquid chamber 115 are suctioned (together with liquid) via the air bubble venting slit 1151 in the common liquid chamber 115, and the air bubble venting process in the common liquid chamber 115 is performed. The maintenance control unit 244 controls the timer unit 241 to track the elapsed time since the start of the air bubble venting process.

Next, the maintenance control unit 244 determines whether the elapsed time since the start of the air bubble venting process has reached the air bubble venting process time (set time) that has been set and stored in the memory 482, the memory of maintenance control unit 244, and the like in advance (ACT 43). When it is determined that the elapsed time since the start of the air bubble venting process has not reached the air bubble venting process time (NO in ACT 43), the maintenance control unit 244 continues the air bubble venting process. When it is determined that the elapsed time since the start of the air bubble venting process has reached the set time (YES in ACT 43), the maintenance control unit 244 stops the suction pump 215 (ACT 44), drives the moving motor 221 (ACT 45), and causes the suction nozzle 211 to move on the backward path.

When the maintenance control unit 244 starts moving the suction nozzle 211 on the backward path, the maintenance control unit 244 monitors whether the suction nozzle 211 is positioned at the original position (ACT 46). When it is monitored that the suction nozzle 211 moved from the first position does not reach the original position (NO in ACT 46), the maintenance control unit 244 continues to monitor the position of the suction nozzle 211. When it is monitored that the suction nozzle 211 is positioned at the original position (YES in ACT 46), the maintenance control unit 244 stops the moving motor 221 (ACT 47). With such configuration, the air bubble venting process and the cleaning process as the maintenance process on the backward path and the backward path are ended. As such, the maintenance control unit 244 performs the air bubble venting process and the cleaning process on the forward path and the backward path as the maintenance process.

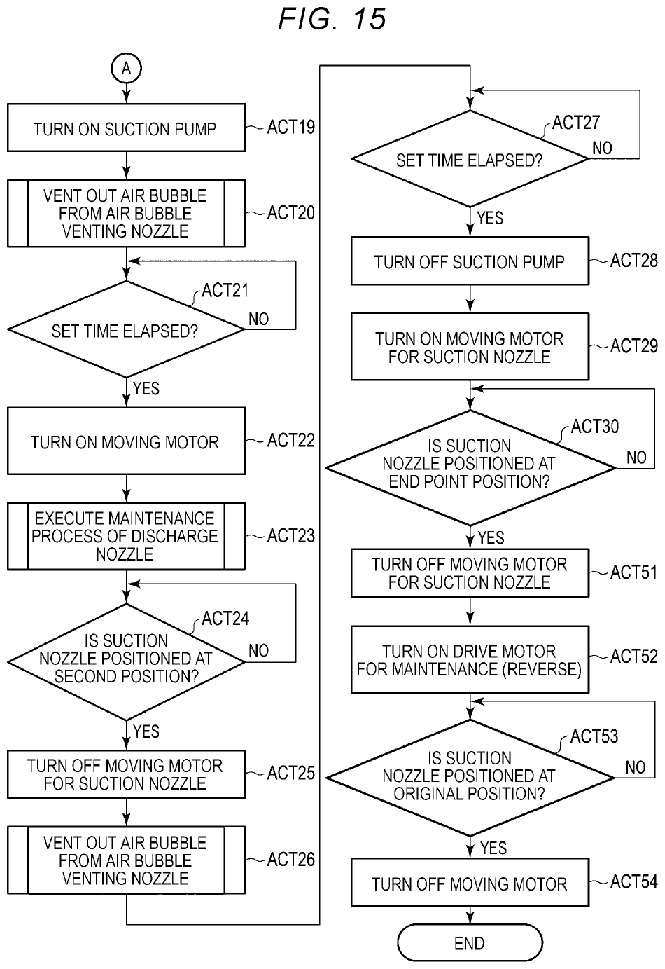

As the maintenance process, a maintenance process may be performed only on the forward path or only on the backward path without performing the air bubble venting process and the cleaning process on the forward path and the backward path. For example, FIG. 15 illustrates an example in which the maintenance process is performed only on the forward path. For example, when the maintenance process is performed only on the forward path, the maintenance control unit 244 performs a process from ACT 11 to ACT 29 as described above. Then, when the suction nozzle 211 is positioned at the end point position in the ACT 30 (YES in the ACT 30), the maintenance control unit 244 stops the moving motor 221 (ACT 51), and reverses the rotation direction of the moving motor 221 from the forward path, drives the moving motor 221 (ACT 52), and starts moving the suction nozzle 211 on the backward path while the suction pump 215 is stopped.

When the movement of the suction nozzle 211 on the backward path is started, the maintenance control unit 244 monitors whether the suction nozzle 211 is positioned at the original position (ACT 53). When it is monitored that the suction nozzle 211 moved from the end point position does not reach the original position (NO in ACT 53), the maintenance control unit 244 continues to monitor the position of the suction nozzle 211. When it is monitored that the suction nozzle 211 is positioned at the original position (YES in ACT 53), the maintenance control unit 244 stops the moving motor 221 (ACT 54). With such configuration, the maintenance process is performed only on the forward path. When the maintenance process is performed only on the backward path, the maintenance control unit 244 moves the suction pump 215 from the original position to the end point position while the suction pump 215 is stopped, and then performs the control from ACT 31 to ACT 47 as described above.

According to the liquid discharge head 100 and the liquid discharge apparatus 1, the mask plate 113 has the first window 1131 for exposing the first nozzle group 1111 for discharging the liquid and the second window 1132 for exposing the second nozzle group 1112 for removing air bubbles. The first window 1131 and the second window 1132 are discontinuous, that is each is a separate, distinct window rather than the same window or sub-portions of the same window. As illustrated in FIGS. 8 to 11, when the nozzle hole 2114 of the suction nozzle 211 faces the second window 1132, the first window 1131 and the second window 1132 are separated so that the nozzle hole 2114 does not face the first window 1131. Therefore, air bubbles can be efficiently removed from the second nozzle group 111 by the suction nozzle 211.

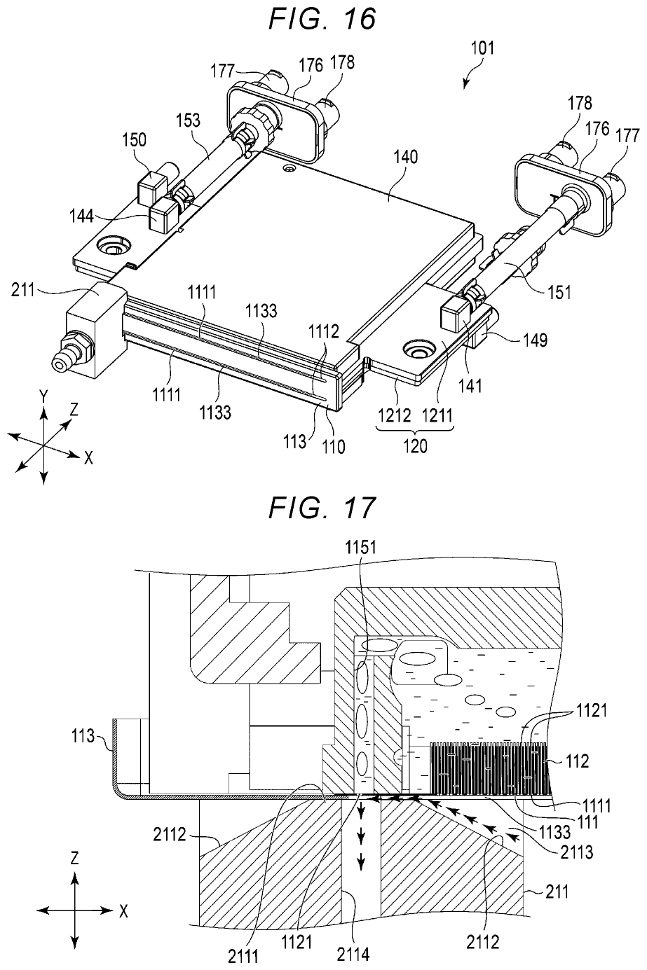

More specifically, in a liquid discharge head 101 of the related art, as illustrated in FIGS. 16 and 17, the mask plate 113 has a window 1133 in which a nozzle row (e.g., a plurality of first nozzle groups 1111) and holes for suctioning air bubbles (e.g., a second nozzle group 1112) are disposed. When the air bubbles in the common liquid chamber 115 are removed via the second nozzle group 1112 of the liquid discharge head 101, as illustrated by an arrow in FIG. 17, a gap larger than that between the suction surface 2111 and the mask plate is left between the suction surface 2111 where the window 1133 is present and the nozzle plate 111. When air is sucked through the gap between the suction surface 2111 and the nozzle plate 111 generated by this window 1133, there can be a problem that the negative pressure (extent of vacuum) used for suctioning out air bubbles via the second nozzle group 1112 is lowered and the air bubbles cannot be sufficiently removed. There may also be a problem that the time required for the air bubble venting process becomes long. However, in the liquid discharge head 100 of the present embodiment, the second window 1132 in which the second nozzle group 1112 is disposed is independent of the first window 1131 and the nozzle hole 2114 does not face the first window 1131 when the nozzle hole 2114 faces the second window 1132. Therefore, since the suction nozzle 211 can suction the air bubbles from the second nozzle group 1112 with a suitable negative pressure, the air bubbles can be reliably removed and the time required for the air bubble venting process can be shortened. As described above, the liquid discharge head 100 and the liquid discharge apparatus 1 according to the present embodiment can efficiently remove air bubbles from the common liquid chamber 115.

According to the liquid discharge head 100 and the liquid discharge apparatus 1 according to an embodiment described above, air bubbles in the common liquid chamber can be efficiently removed via the second nozzle group 1112 through the second window 1132.

The present disclosure is not limited to the specific example embodiments described above and various aspects can be modified in various manners without departing from the gist of the present disclosure.

For example, in an embodiment described above, the bubble venting slits 1151 are provided on both ends of the common liquid chamber 115 in the extending direction, and one bubble venting slit 1151 faces the second nozzle group 1112 provided on the nozzle plate 111, but, in other examples, only one air bubble venting slit 1151 may be provided on an end of the common liquid chamber 115 facing the second nozzle group 1112 in the extending direction.

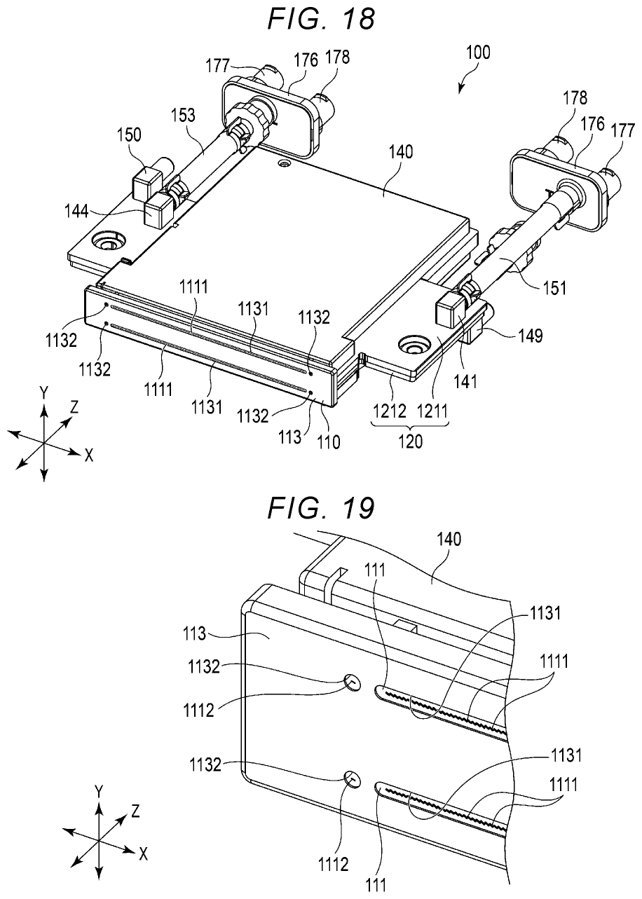

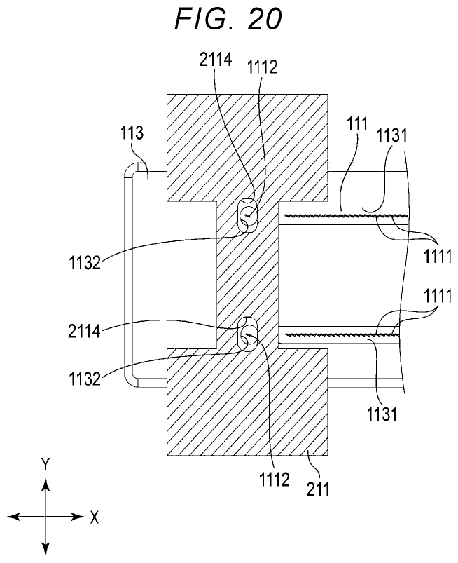

Like the liquid discharge head 100 illustrated in FIGS. 18 to 20, the nozzle plate 111 may have a configuration in which second nozzle groups 1112 are provided at two locations separated from the first nozzle group 1111 positioned at the end portions of the plurality of nozzle groups 1111 aligned in one direction. When such a nozzle plate 111 is adopted, the mask plate 113 can be provided with two second windows 1132 on both end sides in the extending direction of the first window 1131. With such a configuration, in the case of the present example in which the nozzle rows are two rows, four second nozzle groups 1112 are provided on the nozzle plate 111, and four second windows 1132 can be provided on the mask plate 113. With such a configuration, air bubbles can be vent out from the common liquid chamber 115 at both the first position and the second position, and the liquid discharge head 100 can efficiently suction air bubbles from the common liquid chamber 115.

According to at least one embodiment described above, a liquid discharge head and a liquid discharge device have a second window facing a hole for venting out air bubbles in the common liquid chamber, so that the air bubbles can be efficiently removed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid discharge head, comprising:
an actuator with a plurality of pressure chambers;
a cover covering one side of the actuator and including:
a common liquid chamber that connects to the plurality of pressure chambers, and
an air bubble venting flow path connected to the common liquid chamber;
a nozzle plate on a side of the actuator opposite the common liquid chamber and including:
a plurality of first nozzles that faces the plurality of pressure chambers, and
a second nozzle that faces an outlet of the air bubble venting flow path; and
a mask plate covering the nozzle plate on a side opposite of the actuator and including:
a first window exposing the plurality of first nozzles, and
a second window exposing the second nozzle.

2. The liquid discharge head according to claim 1, wherein
the plurality of first nozzles are aligned in a row along a first direction, and
the second nozzle is spaced from an end of the row in the first direction.

3. The liquid discharge head according to claim 2, wherein
the nozzle plate further includes another second nozzle that faces another outlet of the air bubble venting flow path, and
the plurality of first nozzles is between the pair of second nozzles in the first direction.

4. The liquid discharge head according to claim 1, wherein
the plurality of first nozzles are aligned in a row along a first direction, and
each first nozzle comprises three individual nozzles aligned in a direction intersecting the first direction.

5. The liquid discharge head according to claim 1, further comprising:
a liquid inlet connected to the common liquid chamber; and
a liquid outlet connected to the common liquid chamber.

6. The liquid discharge head according to claim 1, wherein
the plurality of first nozzles is arranged in two parallel rows, each row extending in a first direction and separated from the other row in a second direction perpendicular to the first direction.

7. A liquid discharge apparatus, comprising:
a liquid discharge head including:
an actuator with a plurality of pressure chambers;
a cover covering one side of the actuator and including:
a common liquid chamber that connects to the plurality of pressure chambers, and
an air bubble venting flow path connected to the common liquid chamber;
a nozzle plate on a side of the actuator opposite the common liquid chamber and including:
a plurality of first nozzles that faces the plurality of pressure chambers, and
a second nozzle that faces an outlet of the air bubble venting flow path; and
a mask plate covering the nozzle plate on a side opposite of the actuator and including:
a first window exposing the plurality of first nozzles, and
a second window exposing the second nozzle;
a suction nozzle with a suction port facing the nozzle plate; and
a moving mechanism configured to move the suction nozzle to face the plurality of first nozzles and the second nozzle.

8. The liquid discharge apparatus according to claim 7, further comprising:
a control unit configured to control the movement mechanism to position the suction nozzle to face the second nozzle for a predetermined length of time.

9. The liquid discharge apparatus according to claim 7, wherein
the plurality of first nozzles are aligned in a row along a first direction, and
the second nozzle is spaced from an end of the row in the first direction.

10. The liquid discharge apparatus according to claim 9, wherein
the nozzle plate further includes another second nozzle that faces another outlet of the air bubble venting flow path, and
the plurality of first nozzles is between the pair of second nozzles in the first direction.

11. The liquid discharge apparatus according to claim 7, wherein
the plurality of first nozzles are aligned in a row along a first direction, and
each first nozzle comprises three individual nozzles aligned in a direction intersecting the first direction.

12. The liquid discharge apparatus according to claim 7, further comprising:
a liquid inlet connected to the common liquid chamber; and
a liquid outlet connected to the common liquid chamber.

13. The liquid discharge apparatus according to claim 7, wherein the plurality of first nozzles is arranged in two parallel rows, each row extending in a first direction and separated from the other row in a second direction perpendicular to the first direction.

14. The liquid discharge apparatus according to claim 7, wherein the suction nozzle is connected to a vacuum pump.

15. The liquid discharge apparatus according to claim 7, further comprising:
a sensor configured to detect a position of the suction nozzle.

16. The liquid discharge apparatus according to claim 7, wherein the movement mechanism comprises a motor.

17. A liquid discharge head, comprising:
a first actuator with a first plurality of pressure chambers spaced along a first direction;
a second actuator spaced from the first actuator in a second direction perpendicular to the first direction and including a second plurality of pressure chambers spaced along the first direction;
a cover on a first side of the first and second actuators and including:
a first common liquid chamber that connects to first ends of the first plurality of pressure chambers,
a second common liquid chamber that connects to first ends of the second plurality of pressure chambers and
a first air bubble venting flow path connected to an upper end of the first common liquid chamber, and
a second air bubble venting flow path connected to an upper end of the second common liquid chamber;
a nozzle plate on a second side of the first and second actuators opposite the first side and including:
a first plurality of first nozzles that faces the first plurality of pressure chambers,
a second plurality of first nozzles that faces the second plurality of pressure chambers,
a second nozzle that faces an outlet of the first air bubble venting flow path,
a third nozzle that faces an outlet of the second air bubble venting flow path; and
a mask plate covering the nozzle plate on a side of the opposite the first and second actuators and including:
a first window exposing the first plurality of first nozzles,
a second window exposing the second nozzle,
a third window exposing the second plurality of first nozzles, and
a fourth window exposing the third nozzle.

18. The liquid discharge head according to claim 17, wherein the second and third nozzles are on opposite end portions of the nozzle plate in the first direction.

19. The liquid discharge head according to claim 18, further comprising:
a fourth nozzle that faces another outlet of the first air bubble venting flow path; and
a fifth nozzle that faces another outlet of the second air bubble venting flow path, wherein
the first plurality of first nozzles is between the second nozzle and the fourth nozzle, and
the second plurality of first nozzles is between the third nozzle and the fifth nozzle.

20. The liquid discharge head according to claim 17, further comprising:
a suction nozzle with a suction port facing the nozzle plate, the suction nozzle configured to move along the nozzle plate and apply suction to the second and third nozzles.
